(19) United States
(12) Patent Application Publication
(10) Pub. No.: US 2005/0240601 A1
(43) Pub. Date: Oct. 27, 2005

(54) System and method for transactional data collection and processing

(76) Inventors: Mairead Lyons, Dumcondra (IE); Declan Ryan, Rathdrum (IE); Pierre Saurel, DunLaoghaire (IE); Des Cahill, Moone (IE)

Correspondence Address: Brian L. Michaelis;Brown Rudnick Berlack Israels LLP, One Financial Center, Boston, MA, 02111, US

(21) Appl. No.: 10/828,811

(22) Filed: Apr. 21, 2004

(51) Int. Cl. G06F 17/00

(52) U.S. Cl. 707/100

(57) ABSTRACT

A system and method for loading and processing of transaction data is provided. The system and method can obtain transaction data for commercial cards from many feeds with different data formats. A generic file parser is easily modified to account for different data feed formats. Further processing of the transaction data includes sorting the data into multiple temporary tables, which are then resorted in other sorting and processing operations to properly prepare the data for loading into tables in a database. These tables in the database greatly improve the information available to many different parties who need to access the transaction data in the database. The system and method provides the ability to quickly format large amounts of data and insert it into a database with minimal time.

### FIELD OF THE INVENTION

This invention is directed towards data collection and processing, and more particularly towards transaction data collection and processing from disparate sources.

### BACKGROUND

Online transactions are becoming more prevalent. Similarly, online processing of transaction data is common. One area with large amounts of transaction data is credit cards and debit cards. Data from all such credit card transactions is handled electronically, which allows faster transmission of such data, but also creates its own set of problems.

One area of credit card use is the issuing of commercial cards and accounts to employees or agents of a company. Commercial credit cards are the fastest growing payment method in the world for high volume, low value procurement, and also day-to-day travel and entertainment (T&E) expenditures. Procurement expenses in many cases used to require purchase orders or order numbers, which are now more easily purchased with a commercial card. Payments made by commercial cards have been shown to reduce the real cost of processing purchase requisitions and invoices from more than $70 to less than $5 per invoice. T&E expenditures typically include hotels, meals, taxis, airline tickets etc. For example an employee who travels frequently on business would have a credit card to charge all her travel related expenses. The employee then does not need to submit detailed expense reimbursement reports for all her travel expenses, but instead needs only have the credit card statement processed directly by the company. Employees may have several different corporate cards, each for a different purpose.

This great expansion of commercial cards has caused a consequential increase in banks' and companies' accounting issues in handling these transactions. Statements from the credit card issuers must be processed by an accounting department, and expenses properly charged to the proper department or account within the company. The amount of transaction data, the complexity of the data, and the complexity of the company pay structure all create problems.

One problem is that although statements and transaction data from the banks and other credit card issuers is available in electronic format for simplified access, there is no set standard in the industry for the format of such transaction data. This problem is even worse on a global scale. Because they are unable to obtain electronic information in a common or consistent way across international boundaries, multinational businesses and corporation have been unable thus far to establish consistent procurement and expense management across their global operations.

The processing and accounting for electronic transaction data requires different processing based on the format of the data. This limits a company's ability to automatically process the data, and may limit the company's choice of credit card issuers or the providers of the transaction data. The other choice is for a company to enter certain transaction data by hand, or spend time and money to develop preliminary processing applications to handle the different formats of received transaction data. Further, as new formats for transaction data are introduced, or older formats are updated, the transaction data preliminary processing application must be updated. Even using standard formats, such as the XML Document Type Definition (DTD), formats must get updated as data sent by the processors is updated, enhanced or otherwise changed.

Another problem is that within a company such data must often be supplied to and utilized by several departments, which may have different requirements. Different departments would only want some data, for example for employees within that department. Other departments, such as accounting, may want all the transaction data entered into their general ledger, but they are not responsible for payment, which may be processed through other costs centers. Finally, different departments even within one company may want transaction data provided in different formats. This problem becomes more difficult when commercial card services are provided by a banking institution, which will have several different commercial clients who want customizations for their business model.

With so many requirements on what transaction data is used by certain departments, and also what format the departments want the data, a typical approach is to store the data in a database that allows access through querying interfaces, such as an SQL (structured query language) compliant interface. This allows each party's department to access and use the data in the form most convenient to them. For example the database accumulates the transaction data so that each department can access all data over a time period of their choosing.

But storing the transaction data in a database is problematic. Even separate from the problem of different formats on the transaction data feed, the transaction data is not in the form that can be readily loaded into a database. The transaction data is often acquired in batch, such as a download session from one of the credit card issuers. This download typically may occur on a daily, weekly or longer basis. The amount of data can be large. Aside from preliminary processing of all this acquired data in different formats, the parsing and insertion of the data into a database takes a good amount of time. Therefore the batch processing of transaction data and updating of the database with all the new transaction data can take several hours or longer. Also the process utilizes lots of memory and CPU time resources. Therefore the access to the database during the data download time must be minimized. In consequence, the loading of the new transaction data must be done during the user utilization down times.

### SUMMARY

The present invention is useful in working with transaction data from various sources including company credit cards (corporate cards) and other expense tracking devices. Corporate cards are ideally suited to employees who travel or regularly incur expenses on the organization's behalf. The advantages of the present invention for corporate cards includes the ability to electronically review cardholder transactions daily and browse statements on-line, providing a significant degree of visibility and control over card usage; automatic generation of a downloadable file formatted for upload to a company's general ledger, hugely improving program management and removing manual intervention. Other advantages include the automatic generation of expense claims and review or approval on-line, thereby eliminating the inefficiencies associated with cumbersome expense management processes and employee expense claims; and easily generated comprehensive reports on day-to-day expenditure which establishes a powerful control that is unmatched by other payment methods. Further, the present invention provides common automated data processing for companies across data processors.

The present invention is directed towards a transaction processing system that is very easy to adapt and modify based on the requirements of companies and users. An embodiment of the present invention can easily accept transaction data in various formats, and can quickly be updated for new or changed formats. The embodiment can process the transaction data quickly and place all processed data into a database in much less time than previously required. The database system then allows many different parties and departments to access the data, and also to export the data in a format unique to the requirements of the data accessor. The system is easy to adapt to the needs of the industry. Also, the present invention provides common transaction data representation across data processors.

Another advantages of the present invention include the ability to fast load a large data volume. This provides greater efficiencies including less time that certain data is not accessible to the database users. The system remains potentially available 24/7.

### BRIEF DESCRIPTION OF THE DRAWINGS

The foregoing and other features and advantages of the present invention will be more fully understood from the following detailed description of illustrative embodiments, taken in conjunction with the accompanying drawings in which:

FIG. 1 is an overview of an import processing system in accordance with an illustrative embodiment of the present invention;

FIG. 2A is a block diagram of input parsing processors of the illustrative embodiment;

FIG. 2B is a function flow diagram for the input parsing processors of FIG. 2A;

FIG. 3A provides details of further processing of data and insertion into a database;

FIG. 3B is a flow chart of steps used for improved loading of data into databases according to one embodiment of the present invention.

FIG. 4 illustrates temporary tables shown in FIG. 3;

FIG. 5 is a flow chart for processing and sorting transaction data from the temporary tables;

FIG. 6 provides flow details for loading various codes for the flow chart of FIG. 5;

FIG. 7 provides flow details for processing card balances for the flow chart of FIG. 5;

FIGS. 8A and 8B provide flow details for processing transactions for the flow chart of FIG. 5;

FIG. 9 provides flow details for processing enhanced data for the flow chart of FIG. 5;

FIG. 10 provides details for processing trip legs for the flow chart of FIG. 5;

FIG. 11 is a block diagram showing several transaction tables for structuring data; and

FIG. 12 is a block diagram showing and the relationship between the new transaction and the related data representing the organization.

### DETAILED DESCRIPTION

An embodiment of the present invention provides unprecedented flexibility in the importing, processing and accessing of commercial card data. The system provides simple and secure access to all services from a web browser, including card transactions, eStatement browsing and history navigation, instant on-line management information with downloadable reports, automatic cost allocation at line item level regardless of complexity, and customized file exports which can be downloaded in a format that will load into a company's specific general ledger. Further, the system also provides automatic validation of transactions for VISA tax rule compliance or other national or jurisdictional or credit card processing rules; and generation of evidence and non-evidence for tax reports, all on-line. The system also handles multinational program management including consolidated reports, international tax administration and centralized or decentralized program management, as well as multiple languages and multiple currencies.

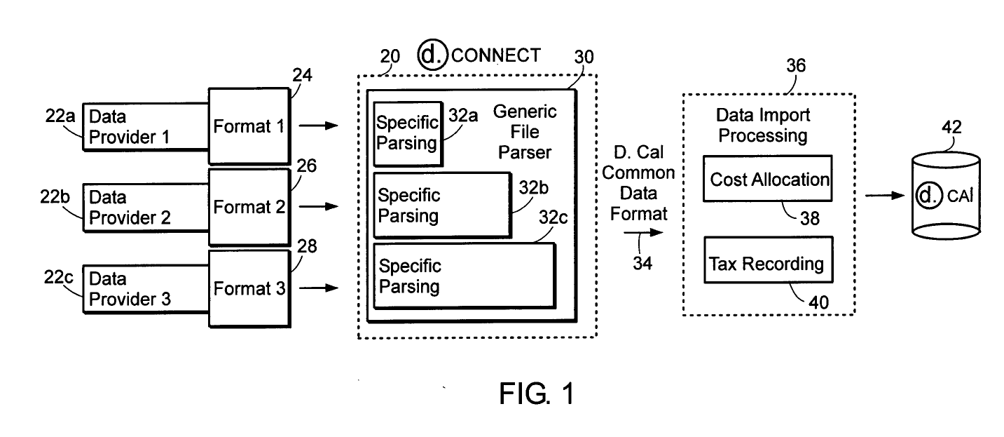

An input processing portion of the present invention is illustrated in FIG. 1. Various data providers 22 provide the transaction data for the system. Such transaction data is obtained typically at certain time intervals, for example once per day. The transaction data is provided in different formats 24, 26, and 28. Typically, the transaction data formats use fixed length fields, plus optional data fields, however there is no set standard in the industry for input data formats. The different formats for the transaction data present a problem for a fast and generic importation and processing of such data.

An illustrative embodiment of the present invention utilizes a parsing utility with a generic file parser 30 to define the most common way to parse a transaction data file. The generic parser defines the typical sequence of events happening during the parsing process. Also it defines the typical data identification and data extraction. The generic parser can typically handle a majority of transaction data. For transaction data in other formats, a specific parser 32a, 32b, or 32c can overwrite any of the functions provided by the generic parser 30. For example, company identification function, card identification function, currency identification function, transaction type mapping function, etc. within the generic parser 30 could all be overwritten by a specific parser. With a minimum effort for specific data parsing 32a, the format 24 from the data provider 22a can be parsed. This allows the illustrative embodiment to easily process a majority of file formats such as format 24.

For the other possible formats 26, 28, the illustrative embodiment uses extensions 32b and 32c to augment the generic file parser 30, to handle the specific features of the other possible formats 26, 28. The extensions 32b and 32c need only address the specific data fields that are different from the generic format. Thus for example, a set of extensions 32b will only need to be coded to handle the specific data records in transaction data format 26 from data provider 22b that are different from the generic format. Some example of differences are company identification data, tax information, field tags, line item details, number or currency conversions, etc. Another different data format 28 would then have a specific set of extensions 32b as a ‘plug-in’ to the generic file parser 30 as needed to parse the data format 28 for that data provider 22c. The specific data parser 32b can also define more important changes such as the sequence of data parsing in case the transaction records in the format 28 are not sorted in the most common order. Also, format 28 could present a different data structure from the common data format. Therefore the data mapping would be more complex. For instance a transaction data record could be spread over multiple records in format 28. The parser 32c would consolidate this information prior to storing it into a single data record of the common format.

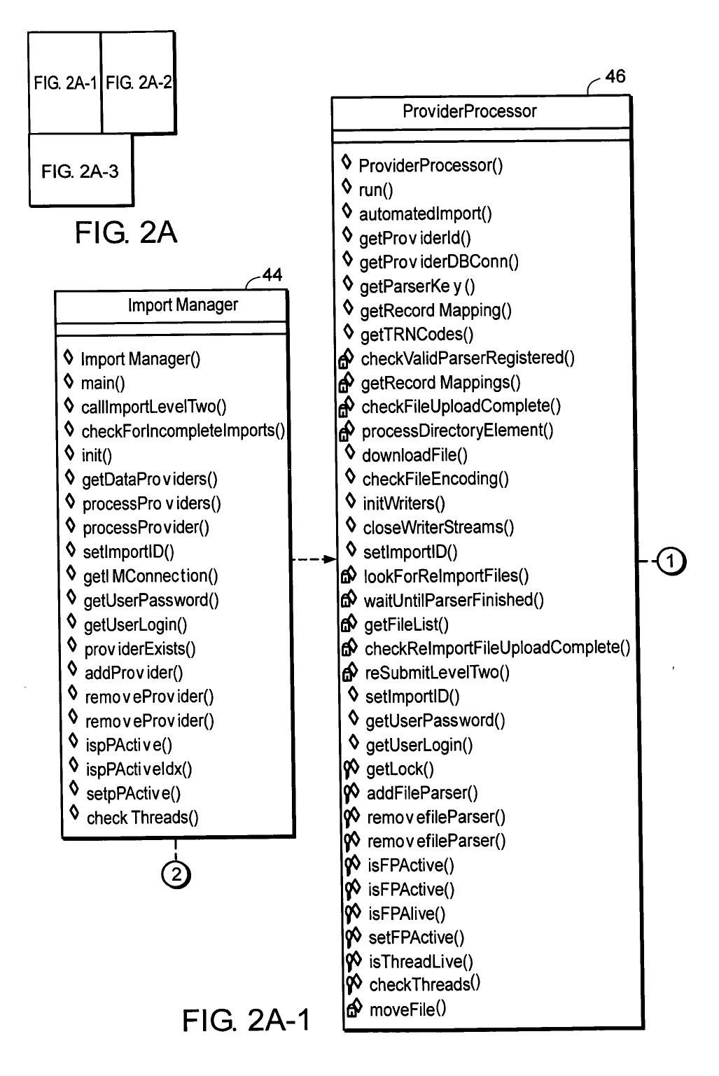

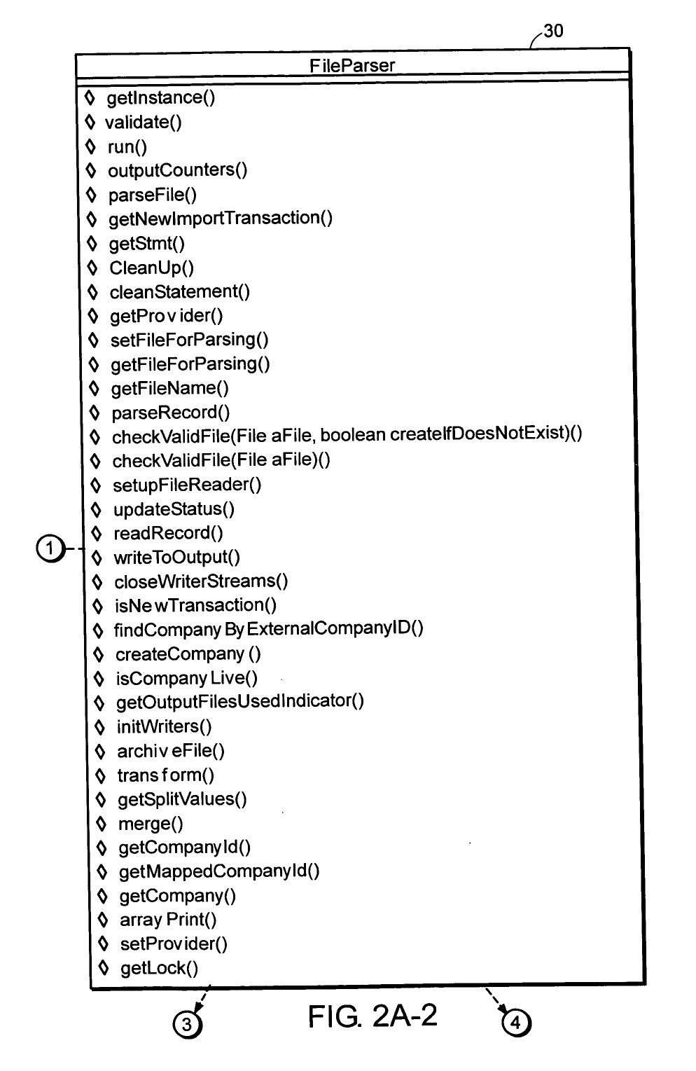

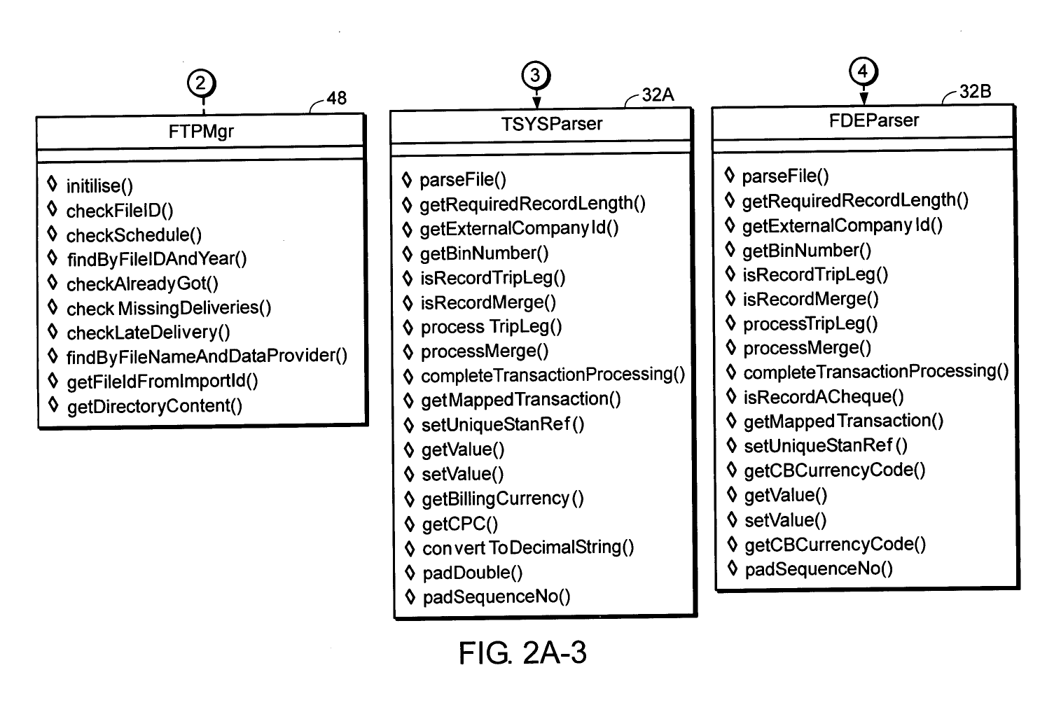

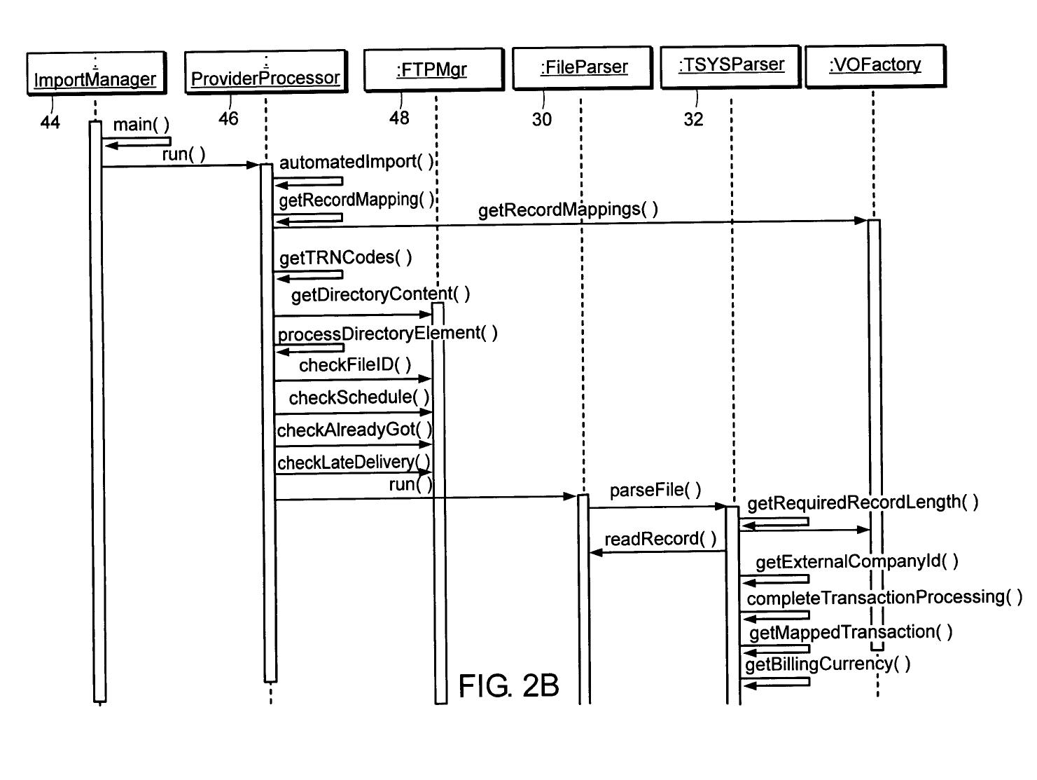

More details of the input processing for the illustrative embodiment are shown in FIGS. 2A and 2B. FIG. 2A shows the main components in the File Parsing Process. The “ImportManager” 44 controls the overall processes. It creates a separate sub-process (thread) for each Data Provider specific parser. Each process is represented by an instance of a “Provider Processor” 46. Each “Provider Processor” uses a dedicated “FTPMgr” 48 instance to access an incoming file in a dedicated recipient. Also, it uses an instance of the specific File Parser (for instance, “FDEParser” 32a for the FDE data processor data format and “TSYSParser” 32b for the Total System data processor data format). The diagram shows the usage of polymorphism (Object Oriented Programming) to represent generic and specific portions of the parsers.

FIG. 2B shows the main sequence of events at data import time. An import manager 44 initiates and controls the accessing and downloading of data from the connection to the data provider 22 (not shown). The import manager 44 loads a provider processor 46 to process data from a transaction data feed for a specific provider. The provider processor 46 then uses an FTP manager process 48 to set up connection to the transaction data feed, and after performing housekeeping activities, the FTP manager process 48 downloads the transaction data. The provider processor 46 then transfers the data to the file specific parser. FIG. 2B shows an example of using the TSYS specific parser 32a (FIG. 2A). Once the function “ParseFile( )” is called by a client component, the call is diverted onto the TSYS Parser if the function has been overwritten or else the call will be diverted into the generic parser. Typically, only about 10% of the total functionality of the file parser 30 needs to be specifically specified by other functionality 32 to handle a new format, however the present invention allows any amount of the generic parser 30 to be modified as is required.

This process allows the illustrative embodiment to be quickly modified to import new or changed data formats with minimal effort by administrators. Only the differences between a generic data format 24 and the new data format need to be identified and coded into the set of parser extensions 32. See FIG. 2A for an example of the number of general parser functions overwritten by the specific FDE Parser 32b or TSYS Parser 32a.

The file parser produces output in a common data format 34, FIG. 1. The common data format 34 used by the illustrative embodiment is disclosed in Appendix A using a DTD (document type definition) format. Another format used by the illustrative embodiment is XML format, which allows the data to be exported to other entities such as companies or banks, if desired.

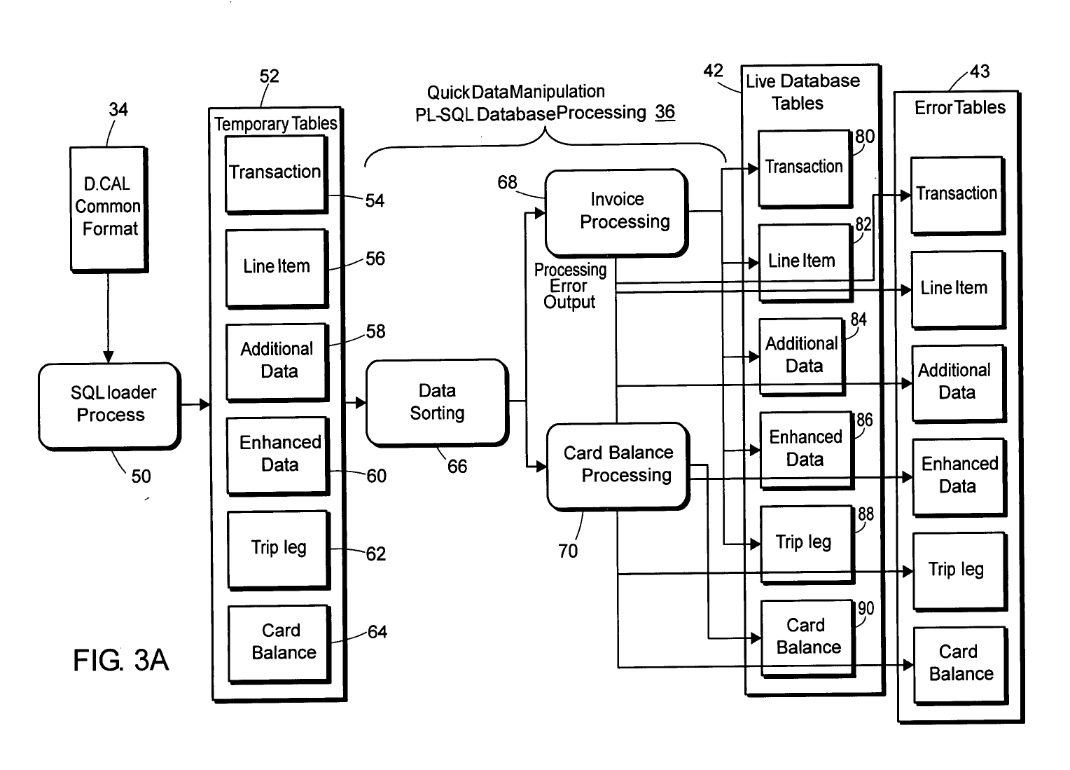

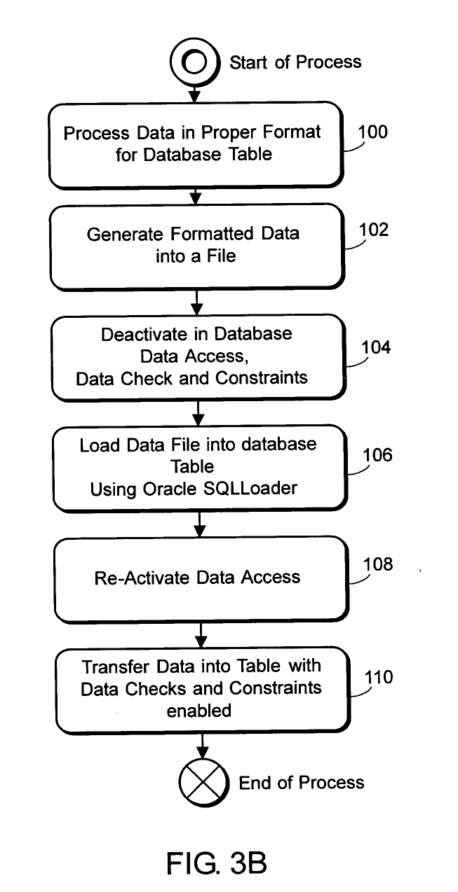

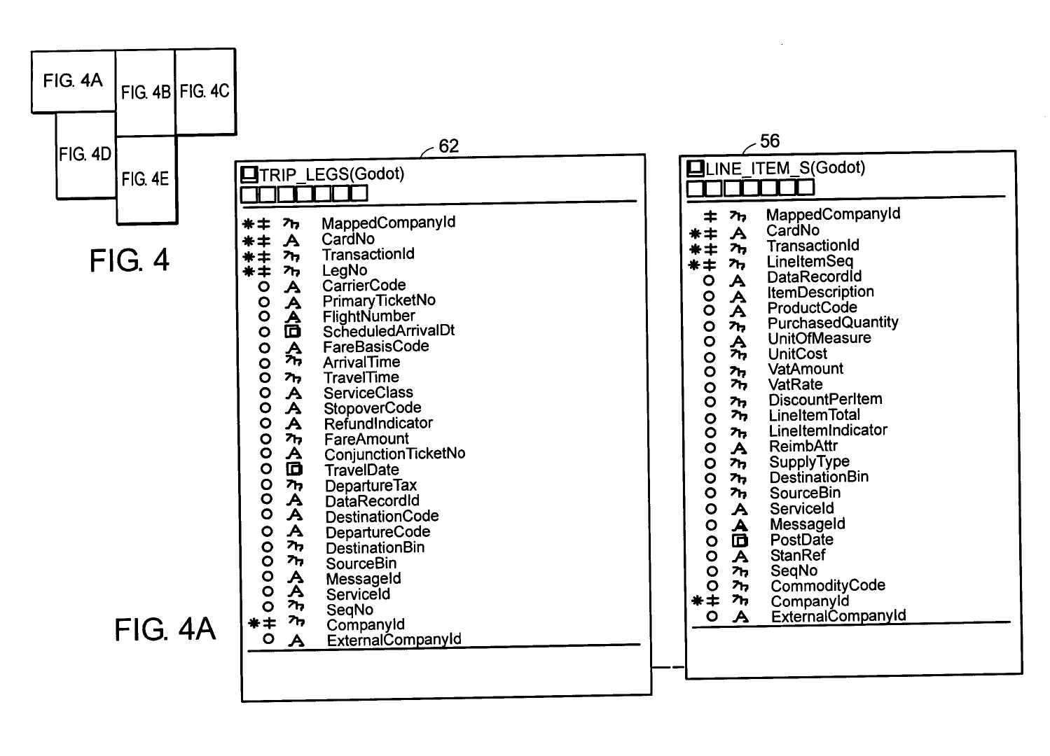

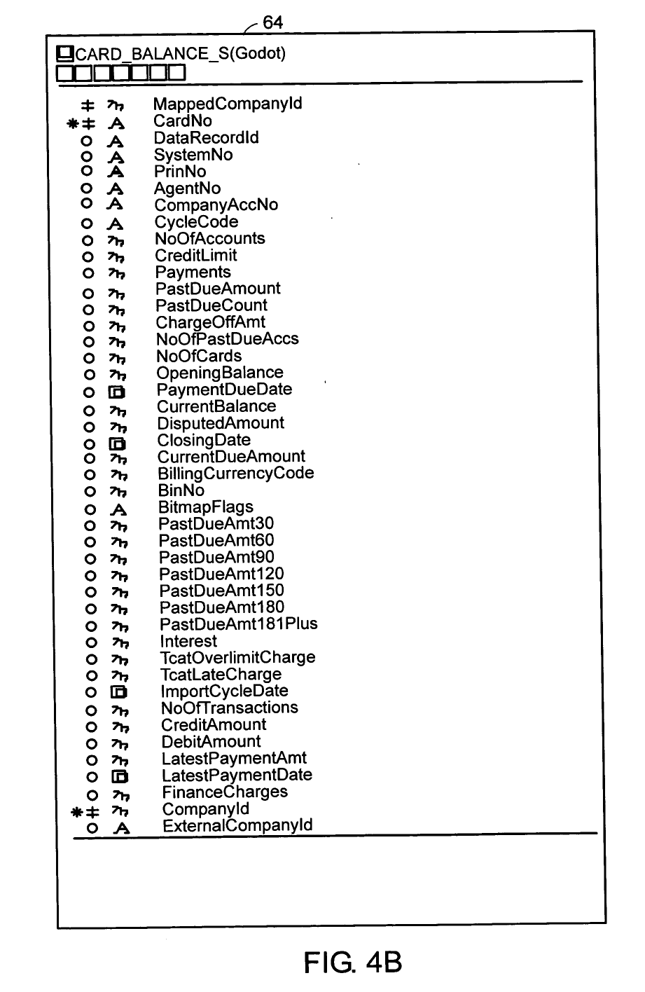

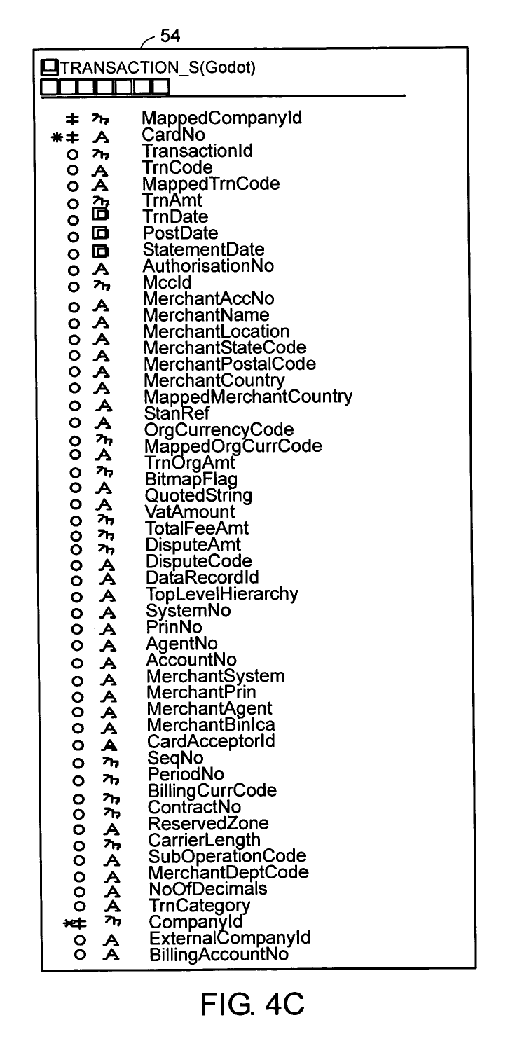

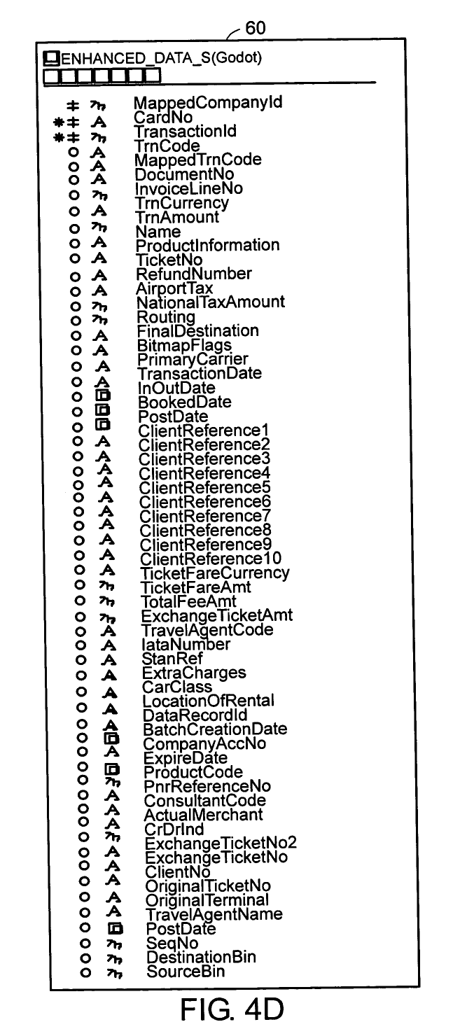

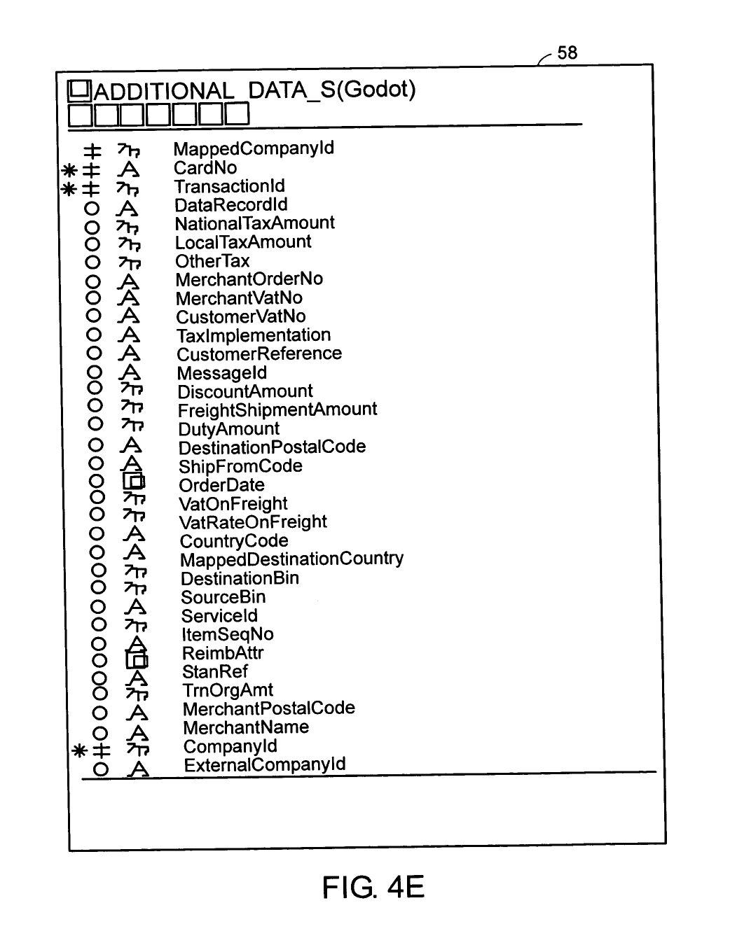

The next step of preliminary processing of transaction data is shown in FIG. 3A. The transaction data now in the common data format 34 is processed for insertion into the database system 42. The transaction data is first processed by a loader processor 50 that loads the transaction data in to a set of temporary tables 52 (shown in FIG. 4). The loader processor 50 is typically an SQL loader processor, thereby sorting the transaction data in accordance with the programmed queries to sort the data into the appropriate temporary tables 52. The six temporary tables used by the illustrative embodiment include transactions 24, line items 56, additional data 58, enhanced data 60, trip leg data 62 and card balance information 64. More information on these tables is shown in FIG. 4. The pre-processing of the data into these temporary tables 52 allows the system to then do a sort of the data 66 FIG. 3A, for the proper format for ultimate entry into the database 42. Since the structure and format of the data for the database 42 is very different than the input format of transaction line feed data from the card providers, this use of temporary tables 52 is an intermediate step that assists in sorting the data before it is ready to be placed in the database 42. Temporary tables typically do not have interdependencies or linked relations, which happens later in the process of data sorting discussed hereinafter. The temporary tables also hold more information than is ultimately stored in the database 42. This information is useful for data processing operation 68 and operation 70, for example extra columns in the tables for record types, and flags.

FIG. 3B shows a feature of the illustrative embodiment which is the ability to quickly insert all new processed data into a database system. For example, for the illustrative embodiment, the processing of temporary tables 52 FIG. 4, of data allows fast insertion into an Oracle brand database. Although the illustrative embodiment focuses on an Oracle database, the present invention will work with any of various types of databases as long as the database offers a utility similar in functionality to Oracle SQL Loader. If the transaction data was ultimately inserted into the database by a normal SQL or other access/write operation, the data entry would take far too long to be practical. The illustrative embodiment uses the steps outlined in FIG. 3B. The transaction data is processed to be in the proper format as required for the temporary database tables, step 100. The required format is the same as how the table is searched in the database, as one example, comma separated data is converted into line separated data. The processed data is then placed in a file, step 102. The next step is to prevent database accessing to the specific table, therefore that table in the database is locked to avoid other accesses of the data during this updating, and then data checking and other constraints are deactivated, step 104. Other tables in the database may still have full access. The data is then directly loaded into the database table, step 106. For the example of the Oracle database, the Oracle SQLLoader utility is utilized. Since relational links or other constraints are typically not included in these temporary tables, the loading is fast. Once this is complete, the database table can be unlocked to again allow access to that table data, step 108.

The last step 110 is the transferring of data from the temporary tables 52 FIG. 3A into the final database tables 42, and also recording any detected errors into appropriate error tables 43. This step 110 FIG. 3B is typically performed by an incremental loader with data checks and constraints enabled. This loading is also efficient because there is no dependence upon using SQL accessing functionality to insert data into the database. Additionally, data links, relations and other additional data may be loaded into the table final tables 42, as will be described hereinafter.

The sorting operation 66 FIG. 3A and final insertion of data is generally performed as two separate operations, invoice (transaction) processing 68, and card balance processing 70. Each operation uses separate SQL statements to the sorting operation 66 to retrieve data from the temporary tables 52 as required. The results of each operation is the processing of the data and insertion into the database 42 in association tables similar to the temporary tables 52, however the data has additionally been processed with relational links for the requirements of transaction and card balance information retrieval. Further, errors that are detected during processing are then stored in corresponding error tables 43 in the database, thereby allowing for later reconciliation of transaction errors. For instance, a mandatory field (e.g. transaction currency) could be missing from the transaction data record or a field referring to a code such as Merchant Category Code would not match to any existing code in the system, this would result into an error as the system guarantees referential integrity. Also, extra data available in the temporary tables 52 may not be inserted into the database 42, such as some enhanced data 60 which is used for this step of processing but is not needed afterwards. For example, codes specific to the data provider are used for mapping to a system internal code at data processing time but is not stored in the D.CAL system.

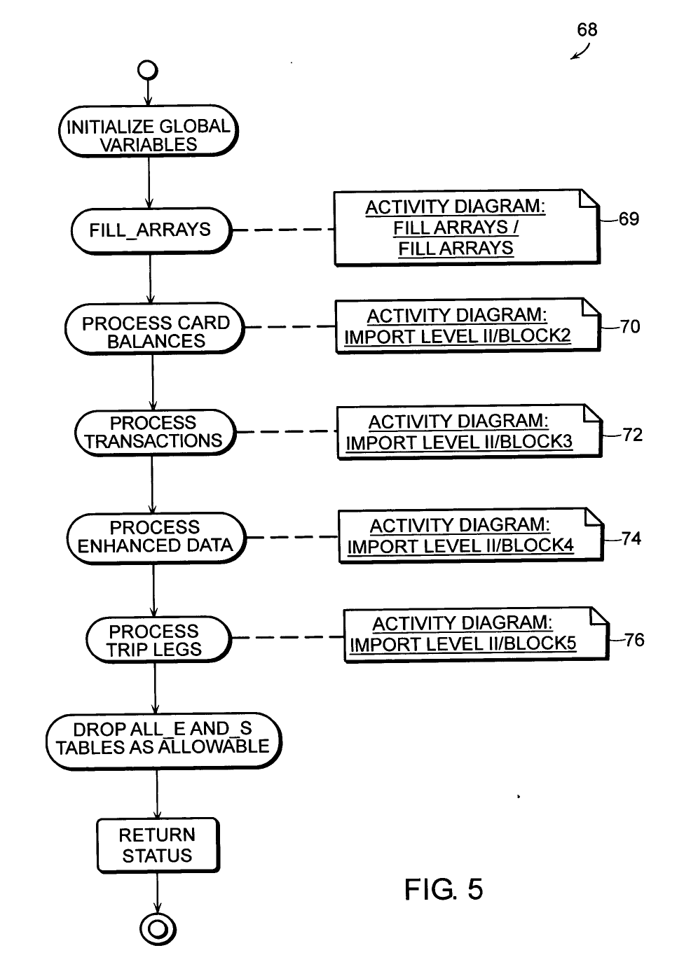

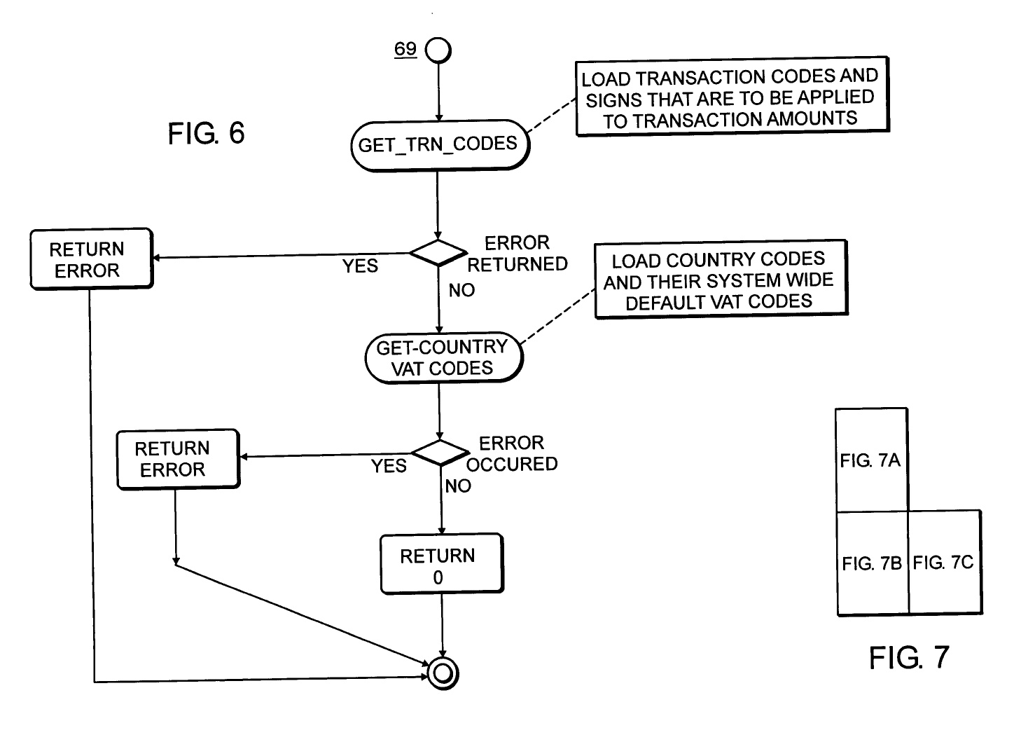

Details of the invoice processing step 68 are shown in FIG. 5. The goal of invoice processing 68 is to identify, sort and format the transaction data as generally needed to use the information for invoicing, entry into ledgers, cost center accessing etc. A preliminary step 69 is the loading of transaction codes and country codes, including VAT (value added tax) codes, as detailed in FIG. 6. This step allows for the further processing as set forth in FIG. 5.

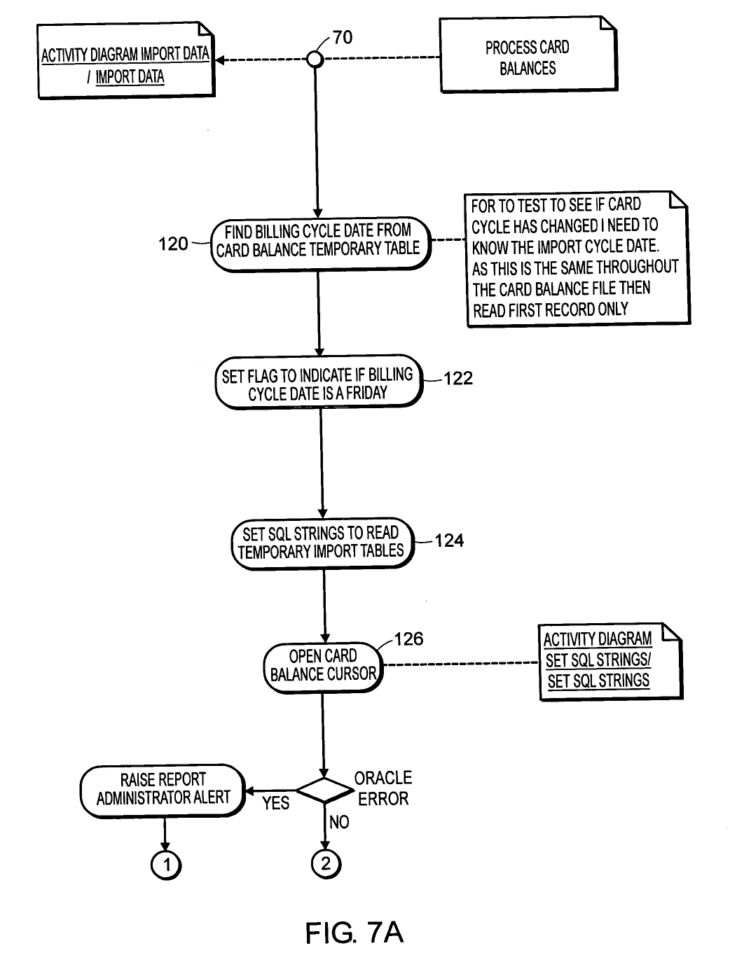

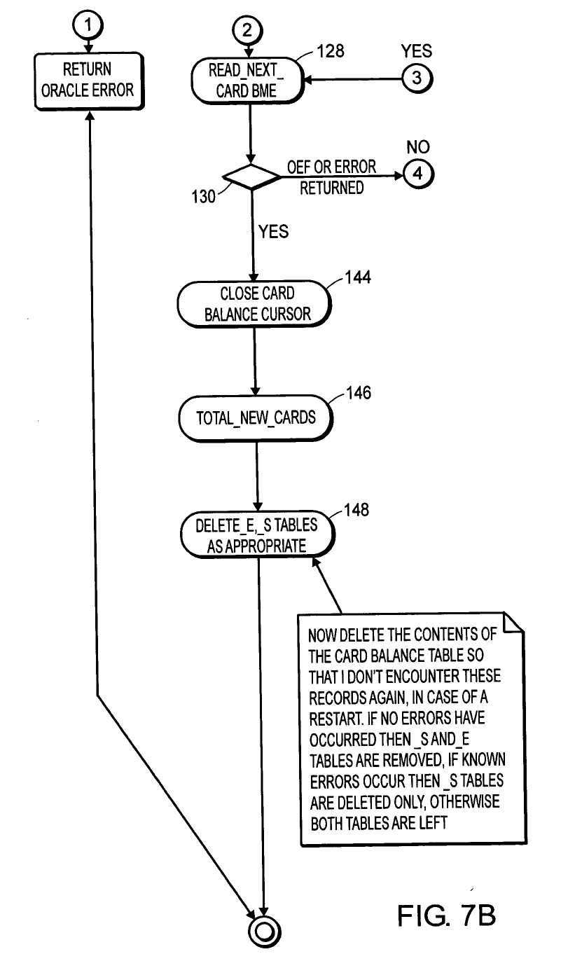

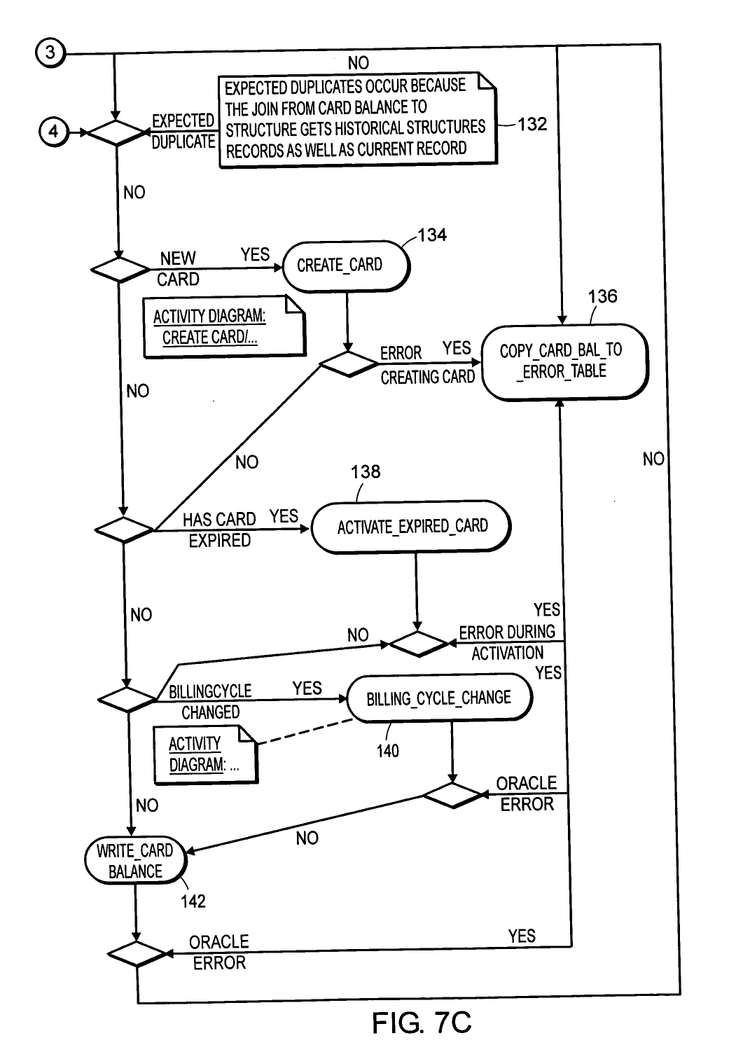

The next step is card balance processing 70, with details provided in FIG. 7, where the goal is to process the account information for specific cards. This generally involves working with details of the specific card account, including retrieving billing cycle information and storing the end of cycle account balance. The process begins with obtaining the billing cycle date from the temporary table, step 120. This will later be compared to the stored billing cycle date for the card account, to determine and note if the billing cycle may have changed. Next, if the billing cycle date falls on a Friday, a flag is set, step 122. This is helpful because transaction data is not provided on Saturday or Sunday. If the billing cycle date is a Friday, then depending on when the transaction data is loaded, any transaction data from a Saturday or Sunday will not yet be captured until the following processing day.

At step 124, the temporary tables will be accessed using SQL queries, therefore SQL query strings are set to access transaction information from the temporary tables. The card balance temporary table is opened, with a position cursor set up, step 126. Provided that no error occurred in opening the database temporary table, the transaction entries are read and processed one by one, step 128. After reading one entry, and checking to make sure that an end of file was not encountered, step 130 (which would indicate that all entries in the table have been read), the system checks to see if the entry is a duplicate of a previous stored entry, step 132. This may happen because of historical information stored in the database based on a company's parameters for allowing access to information within the system. If it is a duplicate, then the entry is discarded.

At step 134, the system checks the database to determine if the card number for the transaction represents a new card. A feature of the illustrative embodiment is the ability to detect new cards from either the processed transaction or the processed card balance, which have been issued but do not yet have account information entered into the system. Whenever a transaction is received and loaded there is a card number field. That card number field is checked against the database and if it exists, the transaction is processed against that card number. Otherwise a new card has been detected. The system, upon detecting a new card, sets up a dummy or decoy account for the card, and can record the transaction details to that dummy account, which can have the unknown details filled in later by a system administrator. This feature is valuable for markets where the information regarding new cards is not supplied with the transaction data. The transactions are still properly recorded, so it is easy to update the information on the new card, instead of having to re-run transaction data that could not be captured without an existing card account. If an error occurs in setting up a dummy card account, the error is recorded into the error table 43 FIG. 3A, step 136 FIG. 7.

If the card number has expired, the expired card is re-activated, step 138. This can occur when transaction data comes in for a card that is indicated by the system to have expired. Since transaction information is not always promptly provided, for example trip leg data, or data with dates near the end of one month, a card may be marked as expired but transaction data is received for it, and this data must be properly recorded. Therefore the card is marked as reactivated, step 138. If an error occurs during re-activation, it is recorded to the error table, step 136.

If a billing cycle date change did occur, as previously discussed with step 120, the change is recorded to the database, step 140. If an error occurs, it is recorded to the error table, step 136.

The card balance information for the transaction is finally written to the database, step 142. Again, if an error occurs, it is recorded to the error table, step 136. The system then repeats to read the next entry step 128 and repeat the cycle. When the end of file is detected, step 130, the access to the temporary files is closed, step 144. At step 146, the system makes a list of all new cards set up as part of step 134. This list is then used to indicate the number of new cards detected and the system can then be updated with the missing information for those new cards.

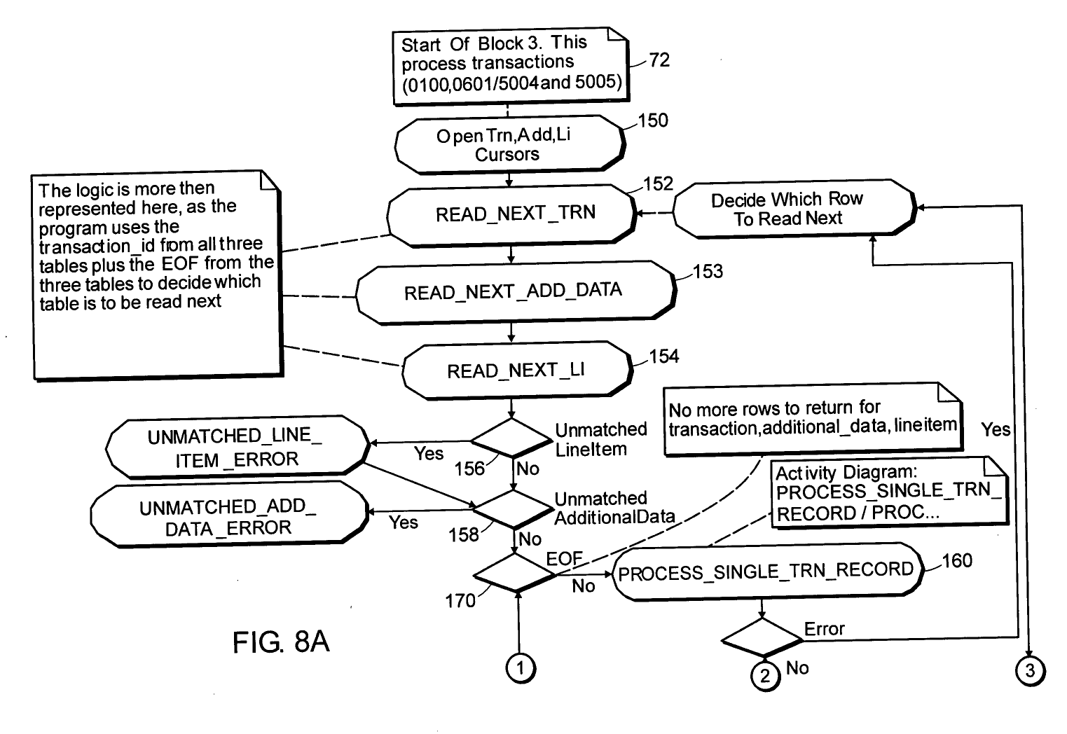

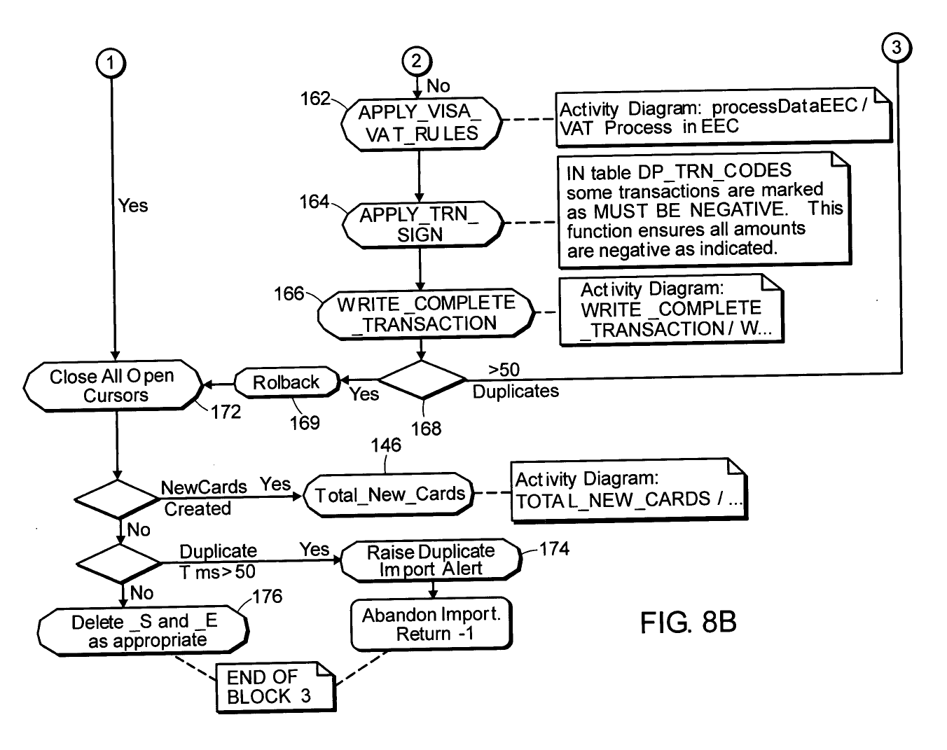

Turning back to FIG. 5, the next step is transaction processing 72, with details provided in FIGS. 8A and 8B. Three temporary tables are opened, the transaction table 24 FIG. 3A, line item table 56, and the additional data table 58, as shown in step 150, FIG. 8A. Another feature of the illustrative embodiment is the ability to capture and use line item details. When suppliers are capable of providing Addendum or Line Item Detail (LID) from their point of sale terminals, the electronic invoice can be used to generate “evidence for tax” reports where no further paperwork is required to recover tax. This line item detail is maintained with the transaction data in the system.

All three temporary tables are accessed for items with the same transaction id, steps 152-154. An entry with the same transaction id should be found in each table. If an unmatched entry is found in the line item table 156 or additional data table 158, an error is signaled. The system then processes through the accessed transaction record, step 160, unless no more transaction records exist in the tables, as indicated by step 170. Unless processing the transaction record results in an error, the transaction record is then marked for VAT (value added tax) processing, step 162, using the country VAT tables loaded as indicated hereinbefore.

Next, the sign on the transaction amount may need to be corrected, step 164. This occurs because some transactions may be marked as positive (for example, as a payment instead of a purchase), and the sign must be changed to properly indicate the bookkeeping operation. The system maintains a table of transactions that must be marked as negative, and changing the sign catches several errors which might later need to be resolved. Once the VAT and sign correct is completed, the transaction is written to the database, step 166.

If the transactions indicate an excessive number of duplicate entries step 168, then processing is aborted, step 169 and an alert is raised to indicate a problem with the number of duplicate transaction entries, step 174. Otherwise processing continues by reading the next transaction entry from the temporary tables, steps 152-154. Once no more entries are present in the temporary tables, step 170, the table accesses are closed, step 172. If new card numbers were detected and new card accounts created, the number is reported, step 146, as previously described. Finally, the temporary tables are deleted, step 176.

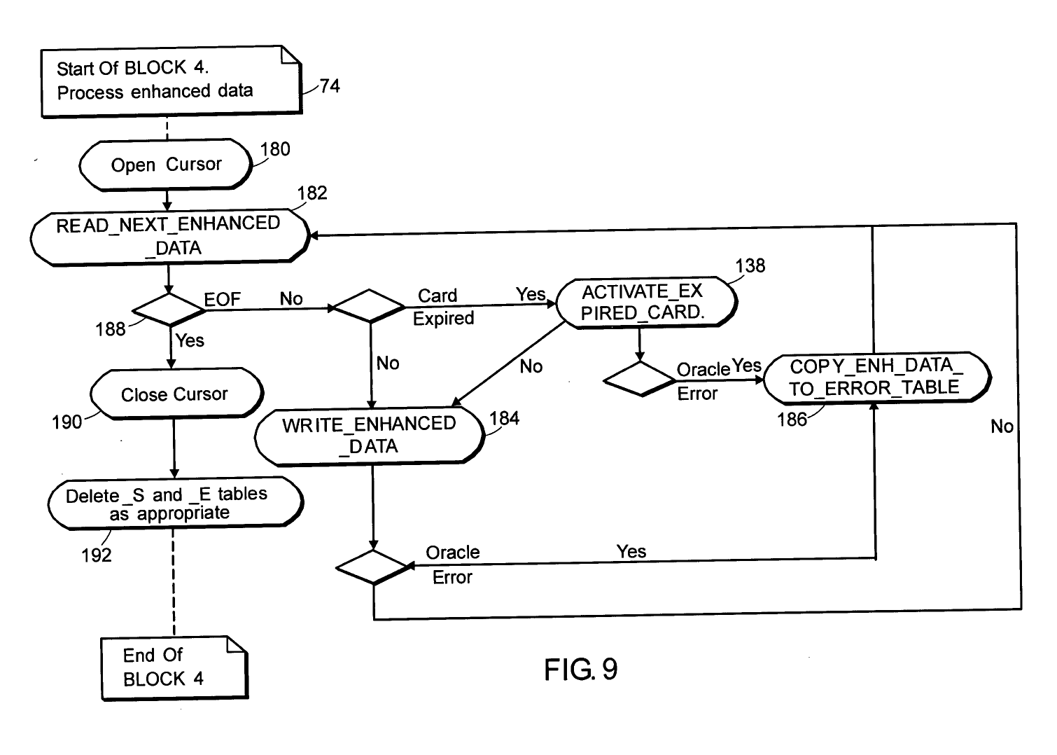

The next processing step as shown in FIG. 5 is processing of enhanced data 74, with details provided in FIG. 9. The enhanced data temporary table 60 FIG. 3A is accessed, step 180 FIG. 9. The next item is read, step 182. If the item is for a card that has expired, the card is reactivated as previously described, step 138. If any errors occur, they are recorded to the enhanced data error table, step 186. Otherwise the enhanced data record is written into the database, step 184, and the process is repeated until no more entries can be read, step 188. The temporary table access is then closed, step 190, and the table is deleted, step 192.

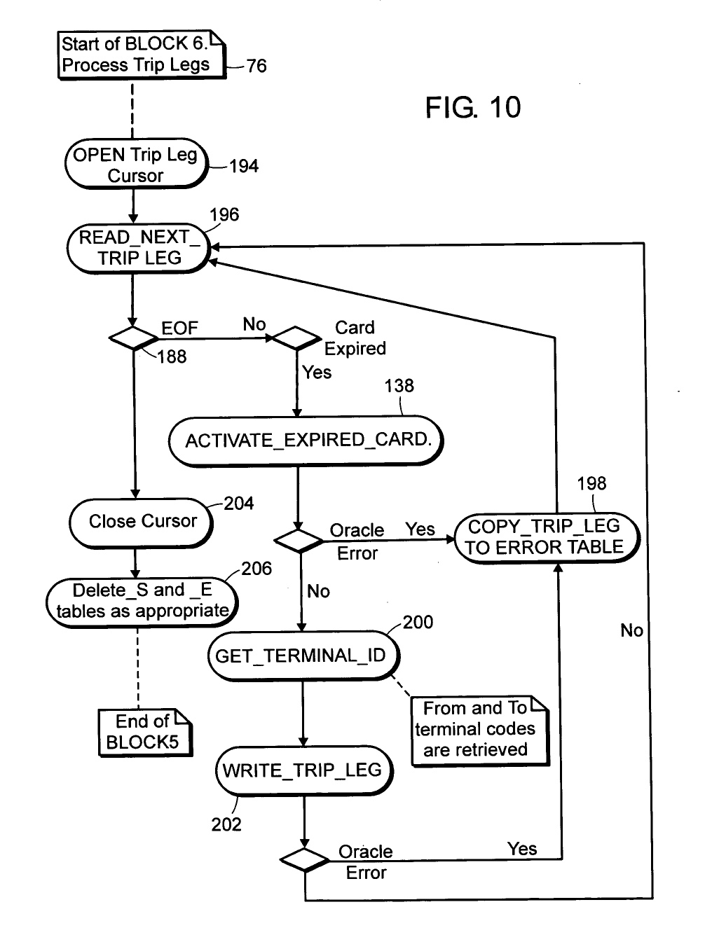

The next step for the processing of transactions as outlined in FIG. 5 is the processing of trip leg data 76, with details provided in FIG. 10. Trip legs are generally related to information regarding travel charges, typically flight or train information, etc. This information is valuable for travel expense claim by providing details on the nature of the expenses. The trip leg temporary table 62 FIG. 3A is accessed, step 194 FIG. 10. The next item is read, step 19, and if it is for a card that has expired, the card is reactivated as previously described, step 138. If any errors occur, they are recorded to the trip leg error table, step 192. Otherwise an airport terminal identification is linked in for the record, step 200, and the trip leg record is written into the database, step 202. This processing continues with the following entries in the temporary table until all entries have been read, step 198. The temporary table is then closed, step 204, and it is then deleted, step 206.

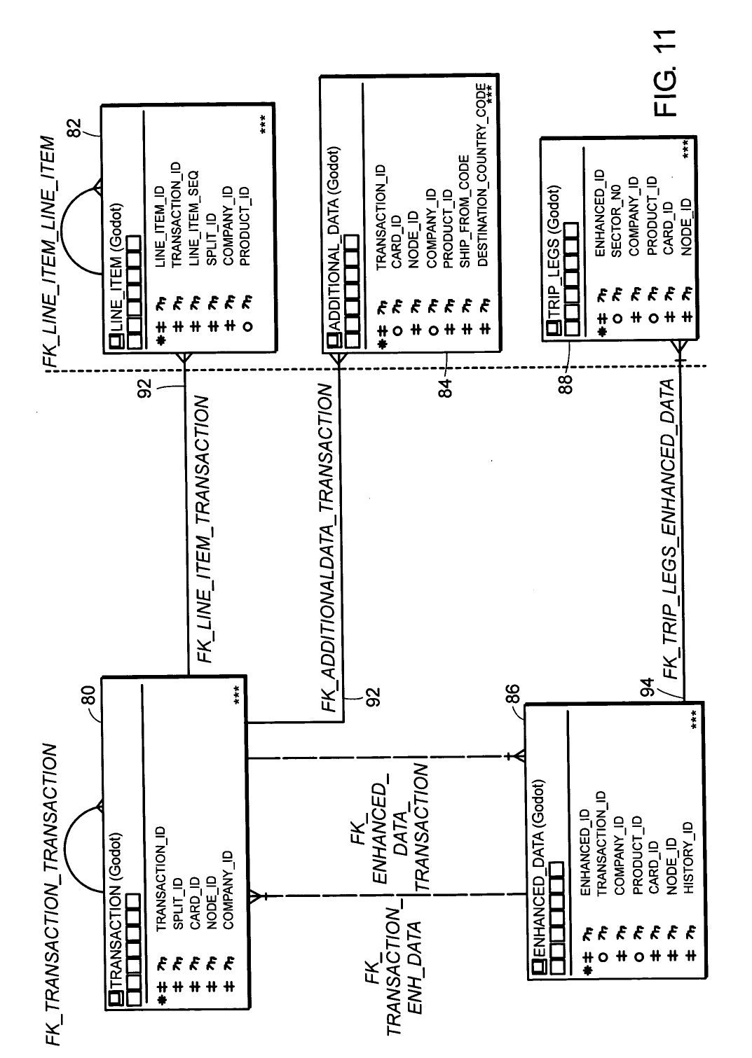

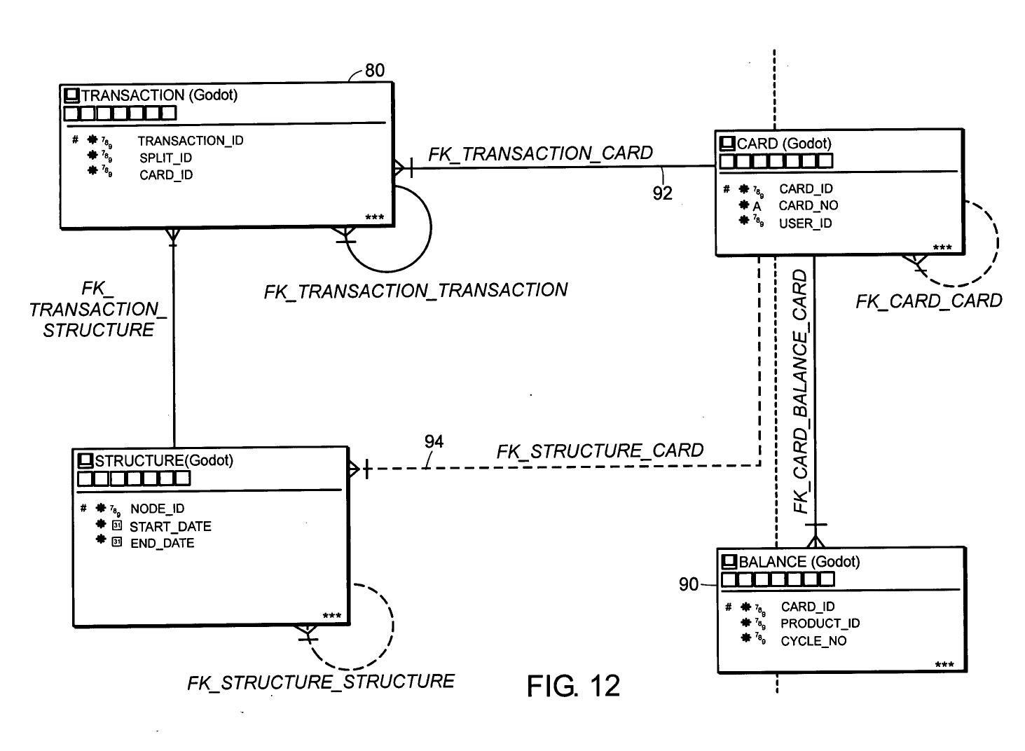

FIG. 11 provides some details and structure of the final database tables 42 including the transaction table 80, the line item table 82, the additional data table 84, the enhanced data table 86, and the trip legs table 88, along with some relational links 92, 94 between these tables within the database 42. The relational links indicated by solid lines are mandatory in the illustrative embodiment, the data line links are optional depending on the system. These links are part of what provides enhanced data access in the present invention, in that related data in the different tables is properly linked together, typically by transaction, to allow easy access and retrieval. FIG. 12 provides some details and structure for the card balance table 90, along with relational links to other structures and tables (including the transaction table 80) within the database system.

Although the illustrative embodiment herein is disclosed as having two specific parsers, it should be appreciated that other specific parsers can be implemented as a function of the application and data provided. Additionally, although specific temporary tables are depicted in the illustrative embodiment, it should be appreciated that greater or fewer temporary tables can be implemented as a function of the application and data. Likewise, the number and nature of data base tables can be different as a function of the application and data.

The present invention can be implemented in one processor system with an internal database, or in a networked system with multiple processors and multiple databases and internet connections.

Although the invention has been shown and described with respect to illustrative embodiments thereof, various other changes, omissions and additions in the form and detail thereof may be made therein without departing from the spirit and scope of the invention.

Appendix A

<!-- GoDot standard data feed format DTD

-->

<!-- -->
<!-- -->
<!-- -->
<!-- Copyright (C), Deecal International Ltd., All Rights Reserved -->
<!--

-->

<!ELEMENT GoDotStandardFeed (DataHeader, DataContents,
DataSummary)>
<!ELEMENT DataHeader (DataProvider, Bank, CompanyCreditCard,
CardType, Company)>
<!ELEMENT DataProvider (#PCDATA)>
<!ATTLIST DataProvider DataProviderId CDATA #REQUIRED
DataProviderName CDATA #IMPLIED
<!ELEMENT Bank (#PCDATA)>
<!ATTLIST Bank BankId CDATA #REQUIRED BankName CDATA
#IMPLIED
<!ELEMENT CompanyCreditCard (#PCDATA)>
<!ATTLIST CompanyCreditCard CompanyCreditCardId CDATA
#REQUIRED CompanyCreditCardName CDATA #IMPLIED
<!ELEMENT CardType (LODGE | PCARD | CCARD)
#REQUIRED>
<!ELEMENT Company (#PCDATA)>
<!ATTLIST Company MappedCompanyId CDATA #REQUIRED
CompanyId CDATA #REQUIRED CompanyName CDATA #IMPLIED
<!ELEMENT DataContents (Card*, Invoice*, CardBalance*)>
<-- **************** Card definition *************-->
<!ELEMENT Card (MappedCompanyId, CompanyId, External-
CompanyId, CardNo, DataRecordId, ClosingDate, CardholderId,
HierarchyNode, ApplicableDate, OpenDate, ExpireDate,
LastRevisionDate, MappedCardType, BitmapFlags,
TrnSpendingLimit, TrnDlrLimit, BillingCtrlAcc,
CostCenter, GlSubAccount, Name, PlaceOfEmployment, AddressLine1,
AddressLine2, DateOfBirth, CardAnnualFee, DobShort,
City, PostalCode, CodeForHoldStatement, CycleCode, PhoneNo,
SpendingCatCodes, CreditLimit, JobTitle, EmbossedName,
MaidenName, EmployeeId, PaymentDueDate, EmailAddress, FirstName,
LastName, CompanyAccNo, StateCode, CountryCode,
MappedCountryCode)>
<!ELEMENT MappedCompanyId (#PCDATA)>
<!ELEMENT CompanyId (#PCDATA)>
<!ELEMENT ExternalCompanyId (#PCDATA)>
<!ELEMENT CardNo (#PCDATA)>
<!ELEMENT DataRecordId (#PCDATA)>
<!ELEMENT ClosingDate (#PCDATA)>
<!ELEMENT CardholderId (#PCDATA)>
<!ELEMENT HierarchyNode (#PCDATA)>
<!ELEMENT ApplicableDate (#PCDATA)>
<!ELEMENT OpenDate (#PCDATA)>
<!ELEMENT ExpireDate (#PCDATA)>
<!ELEMENT LastRevisionDate (#PCDATA)>
<!ELEMENT MappedCardType (#PCDATA)>
<!ELEMENT BitmapFlags (#PCDATA)>
<!ELEMENT TrnSpendingLimit (#PCDATA)>
<!ELEMENT TrnDlrLimit (#PCDATA)>
<!ELEMENT BillingCtrlAcc (#PCDATA)>
<!ELEMENT CostCenter (#PCDATA)>
<!ELEMENT GlSubAccount (#PCDATA)>
<!ELEMENT Name (#PCDATA)>
<!ELEMENT PlaceOfEmployment (#PCDATA)>
<!ELEMENT AddressLine1 (#PCDATA)>
<!ELEMENT AddressLine2 (#PCDATA)>
<!ELEMENT DateOfBirth (#PCDATA)>
<!ELEMENT CardAnnualFee (#PCDATA)>
<!ELEMENT DobShort (#PCDATA)>
<!ELEMENT City (#PCDATA)>
<!ELEMENT PostalCode (#PCDATA)>
<!ELEMENT CodeForHoldStatement (#PCDATA)>
<!ELEMENT CycleCode (#PCDATA)>
<!ELEMENT PhoneNo (#PCDATA)>
<!ELEMENT SpendingCatCodes (#PCDATA)>
<!ELEMENT CreditLimit (#PCDATA)>
<!ELEMENT JobTitle (#PCDATA)>
<!ELEMENT EmbossedName (#PCDATA)>
<!ELEMENT MaidenName (#PCDATA)>
<!ELEMENT EmployeeId (#PCDATA)>
<!ELEMENT PaymentDueDate (#PCDATA)>
<!ELEMENT EmailAddress (#PCDATA)>
<!ELEMENT FirstName (#PCDATA)>
<!ELEMENT LastName (#PCDATA)>
<!ELEMENT CompanyAccNo (#PCDATA)>
<!ELEMENT StateCode (#PCDATA)>
<!ELEMENT CountryCode (#PCDATA)>
<!ELEMENT MappedCountryCode (#PCDATA)>
<-- **************** Invoice definition *************-->
<!ELEMENT Invoice ((Transaction, AdditionalData?, LineItem*)?,
(EnhancedData, TripLeg*)? )>
<-- **************** Transaction definition *************-->
<!ELEMENT Transaction (MappedCompanyId, CompanyId, External-
CompanyId, CardNo, TransactionId, TrnCode,
Amount, Date, AuthorisationNo, MccId, Merchant, StanRef, Currency,
TrnOrgAmt, BitmapFlag, QuotedString,
Dispute, DataRecordId, TopLevelHierarchy, AccountNo, SystemNo,
PrinNo, AgentNo, CardAcceptorId, SeqNo,
PeriodNo, BillingCurrCode, ContractNo, ReservedZone, CarrierLength,
SubOperationCode, , NoOfDecimals,
TransactionCategory)>
<!ELEMENT MappedCompanyId (#PCDATA)>
<!ELEMENT CompanyId (#PCDATA)>
<!ELEMENT ExternalCompanyId (#PCDATA)>
<!ELEMENT CardNo (#PCDATA)>
<!ELEMENT TransactionId (#ID)>
<!ELEMENT TrnCode (#PCDATA)>
<!ATTLIST TrnCode DPTrnCode CDATA #REQUIRED MappedTrnCode CDATA
#REQUIRED>
<!ELEMENT Amount (#PCDATA)>
<!ATTLIST Amount TrnAmount CDATA “0” VatAmount CDATA
#IMPLIED TotalFeeAmt CDATA #IMPLIED>
<!ELEMENT Date (#PCDATA)>
<!ATTLIST Date TrnDate CDATA #REQUIRED PostDate CDATA
#REQUIRED StatementDate CDATA #IMPLED>
<!ELEMENT AuthorisationNo (#PCDATA)>
<!ELEMENT MccId (#PCDATA)>
<!ELEMENT Merchant (#PCDATA)>
<!ATTLIST Merchant MerchantAccNo CDATA #REQUIRED
MerchantName CDATA #IMPLIED
MerchantLocation CDATA #IMPLIED MerchantStateCode CDATA
#IMPLIED
MerchantPostalCode CDATA #IMPLIED MerchantCountry CDATA
#IMPLIED
MappedMerchantCountry CDATA #REQUIRED MerchantSystem
CDATA #IMPLIED
MerchantPrin CDATA #IMPLIED MerchantAgent CDATA
#IMPLIED
MerchantBinIca CDATA #IMPLIED MerchantDeptCode CDATA
#IMPLIED>
<!ELEMENT StanRef (#PCDATA)>
<!ELEMENT Currency (#PCDATA)>
<!ATTLIST Currency OrgCurrencyCode CDATA #IMPLIED
MappedOrgCurrencyCode CDATA #IMPLIED>
<!ELEMENT TrnOrgAmt (#PCDATA)>
<!ELEMENT BitmapFlag (#PCDATA)>
<!ELEMENT QuotedString (#PCDATA)>
<!ELEMENT Dispute (#PCDATA)>
<!ATTLIST Dispute DisputeAmt CDATA #REQUIRED DisputeCode
CDATA #REQUIRED>
<!ELEMENT DataRecordId (#PCDATA)>
<!ELEMENT TopLevelHierarchy (#PCDATA)>
<!ELEMENT AccountNo (#PCDATA)>
<!ELEMENT SystemNo (#PCDATA)>
<!ELEMENT PrinNo (#PCDATA)>
<!ELEMENT AgentNo (#PCDATA)>
<!ELEMENT CardAcceptorId (#PCDATA)>
<!ELEMENT SeqNo (#PCDATA)>
<!ELEMENT PeriodNo (#PCDATA)>
<!ELEMENT BillingCurrCode (#PCDATA)>
<!ELEMENT ContractNo (#PCDATA)>
<!ELEMENT ReservedZone (#PCDATA)>
<!ELEMENT CarrierLength (#PCDATA)>
<!ELEMENT SubOperationCode (#PCDATA)>
<!ELEMENT NoOfDecimals (#PCDATA)>
<!ELEMENT TransactionCategory (#PCDATA)>
<-- **************** Additional Data definition *************-->
<!ELEMENT AdditionalData (MappedCompanyId, CompanyId,
ExternalCompanyId, CardNo, TransactionId, DataRecordId,
NationalTaxAmount, Amount, Merchant, CustomerVatNo,
TaxImplementation, CustomerReference, MessageId,
DestinationPostalCode, ShipFromCode, Date, VatOnFreight,
VatRateOnFreight, CountryCode,
MappedDestinationCountry, DestinationBin, SourceBin, ServiceId,
ItemSeqNo, ReimbAttr, StanRef)>
<!ELEMENT MappedCompanyId (#PCDATA)>
<!ELEMENT CompanyId (#PCDATA)>
<!ELEMENT ExternalCompanyId (#PCDATA)>
<!ELEMENT CardNo (#PCDATA)>
<!ELEMENT TransactionId (#IDREF)>
<!ELEMENT DataRecordId (#PCDATA)>
<!ELEMENT NationalTaxAmount (#PCDATA)>
<!ELEMENT Amount (#PCDATA)>
<!ATTLIST Amount LocalTaxAmount CDATA #IMPLIED OtherTax
CDATA #IMPLIED DiscountAmount CDATA #IMPLIED
FreightShipmentAmount CDATA #IMPLIED DutyAmount CDATA
#IMPLIED TrnOrgAmt CDATA #IMPLIED>
<!ELEMENT Merchant (#PCDATA)>
<!ATTLIST Merchant MerchantOrderNo CDATA #IMPLIED
MerchantVatNo CDATA #IMPLIED Merchant PostalCode
CDATA #IMPLIED MerchantName CDATA #IMPLIED>
<!ELEMENT CustomerVatNo (#PCDATA)>
<!ELEMENT TaxImplementation (#PCDATA)>
<!ELEMENT CustomerReference (#PCDATA)>
<!ELEMENT MessageId (#PCDATA)>
<!ELEMENT DestinationPostalCode (#PCDATA)>
<!ELEMENT ShipFromCode (#PCDATA)>
<!ELEMENT Date (#PCDATA)>
<!ATTLIST Date OrderDate CDATA #REQUIRED PostDate CDATA
#REQUIRED>
<!ELEMENT VatOnFreight (#PCDATA)>
<!ELEMENT VatRateOnFreight (#PCDATA)>
<!ELEMENT CountryCode (#PCDATA)>
<!ELEMENT MappedDestinationCountry (#PCDATA)>
<!ELEMENT DestinationBin (#PCDATA)>
<!ELEMENT SourceBin (#PCDATA)>
<!ELEMENT ServiceId (#PCDATA)>
<!ELEMENT ItemSeqNo (#PCDATA)>
<!ELEMENT ReimbAttr (#PCDATA)>
<!ELEMENT StanRef (#PCDATA)>
<-- **************** LineItem definition ************-->
<!ELEMENT LineItem (MappedGompanyId, CompanyId,
ExternalCompanyId, CardNo, TransactionId, LineItemSeq,
DataRecordId, ItemDescription, ProductCode, PurchasedQuantity,
UnitOfMeasure, UnitCost, Vat, DiscountPerItem, LineItemTotal,
LineItemIndicator, ReimbAttr, SupplyType, DestinationBin, SourceBin,
ServiceId, MessageId, PostDate, StanRef, SeqNo, CommodityCode)>
<!ELEMENT MappedCompanyId (#PCDATA)>
<!ELEMENT CompanyId (#PCDATA)>
<!ELEMENT ExternalCompanyId (#PCDATA)>
<!ELEMENT CardNo (#PCDATA)>
<!ELEMENT TransactionId (#IDREF)>
<!ELEMENT LineItemSeq (#PCDATA)>
<!ELEMENT DataRecordId (#PCDATA)>
<!ELEMENT ItemDescription (#PCDATA)>
<!ELEMENT ProductCode (#PCDATA)>
<!ELEMENT PurchasedQuantity (#PCDATA)>
<!ELEMENT UnitOfMeasure (#PCDATA)>
<!ELEMENT UnitCost (#PCDATA)>
<!ELEMENT Vat (#PCDATA)>
<!ATTLIST Vat VatAmount CDATA #REQUIRED VatRate CDATA
#REQUIRED>
<!ELEMENT DiscountPerItem (#PCDATA)>
<!ELEMENT LineItemTotal (#PCDATA)>
<!ELEMENT LineItemIndicator (#PCDATA)>
<!ELEMENT ReimbAttr (#PCDATA)>
<!ELEMENT SupplyType (#PCDATA)>
<!ELEMENT DestinationBin (#PCDATA)>
<!ELEMENT SourceBin (#PCDATA)>
<!ELEMENT ServiceId (#PCDATA)>
<!ELEMENT MessageId (#PCDATA)>
<!ELEMENT PostDate (#PCDATA)>
<!ELEMENT StanRef (#PCDATA)>
<!ELEMENT SeqNo (#PCDATA)>
<!ELEMENT CommodityCode (#PCDATA)>
<-- **************** Enhanced Data definition *************-->
<!ELEMENT EnhancedData ( MappedCompanyId, CompanyId,
ExternalCompanyId, CardNo, TransactionId, TrnCode,
DocumentNo, InvoiceLineNo, TrnCurrency, Amount, Name,
ProductInformation, TicketNo, RefundNumber, AirportTax,
NationalTaxAmount, Routing, FinalDestination, BitmapFlags,
PrimaryCarrier, Date, ClientReference, TicketFareCurrency,
TicketFareAmt, TotalFeeAmt, ExchangeTicketAmt, TravelAgentCode,
IataNumber, StanRef, ExtraCharges, CarClass, LocationOfRental,
DataRecordId, BatchCreationDate, CompanyAccNo, ExpireDate,
ProductCode, PnrReferenceNo, ConsultantCode, ActualMerchant,
CrDrInd, ExchangeTicketNo, ExchangeTicketNo2, ClientNo,
OriginalTicketNo, OriginalTerminal, TravelAgentName, SeqNo,
DestinationBin, SourceBin, ServiceId, MessageId
TravelAgentAddress, RecordNumber, RecordNumberRef, Rate,
LocalTaxAmount, Charge, NoOfUnits, OtherTax,
ReturnDestination)>
<!ELEMENT MappedCompanyId (#PCDATA)>
<!ELEMENT CompanyId (#PCDATA)>
<!ELEMENT ExternalCompanyId (#PCDATA)>
<!ELEMENT CardNo (#PCDATA)>
<!ELEMENT TransactionId (#IDREF)>
<!ELEMENT TrnCode (#PCDATA)>
<!ATTLIST TrnCode DPTrnCode CDATA #REQUIRED
MappedTrnCode CDATA #REQUIRED>
<!ELEMENT DocumentNo (#PCDATA)>
<!ELEMENT InvoiceLineNo (#PCDATA)>
<!ELEMENT TrnCurrency (#PCDATA)>
<!ELEMENT Amount (#PCDATA)>
<!ATTLIST Amount TrnAmount CDATA #REQUIRED>
<!ELEMENT Name (#PCDATA)>
<!ELEMENT ProductInformation (#PCDATA)>
<!ELEMENT TicketNo (#PCDATA)>
<!ELEMENT RefundNumber (#PCDATA)>
<!ELEMENT AirportTax (#PCDATA)>
<!ELEMENT NationalTaxAmount (#PCDATA)>
<!ELEMENT Routing (#PCDATA)>
<!ELEMENT FinalDestination (#PCDATA)>
<!ELEMENT BitmapFlags (#PCDATA)>
<!ELEMENT PrimaryCarrier (#PCDATA)>
<!ELEMENT Date (#PCDATA)>
<!ATTLIST Date TransactionDate CDATA #REQUIRED InOutDate
CDATA #REQUIRED BookedDate CDATA #REQUIRED PostDate CADATA
#REQUIRED>
<!ELEMENT ClientReference EMPTY>
<!ATTLTST ClientReference ClientReference1 CDATA
#IMPLIED ClientReference2 CDATA #IMPLIED ClientReference3
CDATA #IMPLIED ClientReference4 CDATA #IMPLIED
ClientReference5 CDATA #IMPLIED ClientReference6 CDATA
#IMPLIED ClientReference7 CDATA #IMPLIED
ClientReference8 CDATA #IMPLIED ClientReference9 CDATA
#IMPLIED ClientReference10 CDATA #IMPLIED>
<!ELEMENT Ticket FareCurrency (#PCDATA)>
<!ELEMENT TicketFareAmt (#PCDATA)>
<!ELEMENT TotalFeeAmt (#PCDATA)>
<!ELEMENT ExchangeTicketAmt (#PCDATA)>
<!ELEMENT TravelAgentCode (#PCDATA)>
<!ELEMENT IataNumber (#PCDATA)>
<!ELEMENT StanRef (#PCDATA)>
<!ELEMENT ExtraCharges (#PCDATA)>
<!ELEMENT CarClass (#PCDATA)>
<!ELEMENT LocationOfRental (#PCDATA)>
<!ELEMENT DataRecordId (#PCDATA)>
<!ELEMENT BatchCreationDate (#PCDATA)>
<!ELEMENT CompanyAccNo (#PCDATA)>
<!ELEMENT ExpireDate (#PCDATA)>
<!ELEMENT ProductCode (#PCDATA)>
<!ELEMENT PnrReferenceNo (#PCDATA)>
<!ELEMENT ConsultantCode (#PCDATA)>
<!ELEMENT ActualMerchant (#PCDATA)>
<!ELEMENT CrDrInd (#PCDATA)>
<!ELEMENT ExchangeTicketNo (#PCDATA)>
<!ELEMENT ExchangeTicketNo2 (#PCDATA)>
<!ELEMENT ClientNo (#PCDATA)>
<!ELEMENT OriginalTicketNo (#PCDATA)>
<!ELEMENT OriginalTerminal (#PCDATA)>
<!ELEMENT TravelAgentName (#PCDATA)>
<!ELEMENT SeqNo (#PCDATA)>
<!ELEMENT DestinationBin (#PCDATA)>
<!ELEMENT SourceBin (#PCDATA)>
<!ELEMENT ServiceId (#PCDATA)>
<!ELEMENT MessageId (#PCDATA)>
<!ELEMENT TravelAgentAddress (#PCDATA)>
<!ELEMENT RecordNumber (#PCDATA)>
<!ELEMENT RecordNumberRef (#PCDATA)>
<!ELEMENT Rate EMPTY>
<!ATTLIST Rate Rate01 CDATA #IMPLIED Rate02 CDATA
#IMPLIED Rate03 CDATA #IMPLIED>
<!ELEMENT LocalTaxAmount (#PCDATA)>
<!ELEMENT Charge EMPTY>
<!ATTLIST Charge Charge01 CDATA #IMPLIED Charge02 CDATA
#IMPLIED Charge03 CDATA #IMPLIED Charge04 CDATA #IMPLIED
Charge05 CDATA #IMPLIED Charge06 CDATA #IMPLIED Charge07
CDATA #IMPLIED Charge08 CDATA #IMPLIED Charge09 CDATA
CDATA #IMPLIED Charge10 CDATA #IMPLIED Charge11 CDATA
#IMPLIED Charge12 CDATA #IMPLIED Charge13 CDATA
CDATA #IMPLIED Charge14 CDATA #IMPLIED>
<!ELEMENT NoOfUnits (#PCDATA)>
<!ELEMENT OtherTax (#PCDATA)>
<!ELEMENT ReturnDestination (#PCDATA)>
<--**************** Trip leg definition *************-->
<!ELEMENT TripLeg (MappedCompanyId, CompanyId,
ExternalCompanyId, CardNo, TransactionId, LegNo,
CarrierCode, PrimaryTicketNo, FlightNo, ScheduledArrivalDate,
FareBasisCode, ArrivalTime, TravelTime, ServiceClass, StopoverCode,
RefundIndicator, FareAmount, ConjuctionTicketNo, TravelDate,
DepartureTax, DataRecordId, DestinationCode, DepartureCode,
DestinationBin, SourceBin, MessageId, ServiceId, SeqNo)>
<!ELEMENT MappedCompanyId (#PCDATA)>
<!ELEMENT CompanyId (#PCDATA)>
<!ELEMENT ExternalCompanyId (#PCDATA)>
<!ELEMENT CardNo (#PCDATA)>
<!ELEMENT TransactionId (#IDREF)>
<!ELEMENT LegNo (#PCDATA)>
<!ELEMENT CarrierCode (#PCDATA)>
<!ELEMENT PrimaryTicketNo (#PCDATA)>
<!ELEMENT FlightNumber (#PCDATA)>
<!ELEMENT ScheduledArrivalDt (#PCDATA)>
<!ELEMENT FareBasisCode (#PCDATA)>
<!ELEMENT ArrivalTime (#PCDATA)>
<!ELEMENT TravelTime (#PCDATA)>
<!ELEMENT ServiceClass (#PCDATA)>
<!ELEMENT StopoverCode (#PCDATA)>
<!ELEMENT RefundIndicator (#PCDATA)>
<!ELEMENT FareAmount (#PCDATA)>
<!ELEMENT ConjunctionTicketNo (#PCDATA)>
<!ELEMENT TravelDate (#PCDATA)>
<!ELEMENT DepartureTax (#PCDATA)>
<!ELEMENT DataRecordId (#PCDATA)>
<!ELEMENT DestinationCode (#PCDATA)>
<!ELEMENT DepartureCode (#PCDATA)>
<!ELEMENT DestinationBin (#PCDATA)>
<!ELEMENT SourceBin (#PCDATA)>
<!ELEMENT MessageId (#PCDATA)>
<!ELEMENT ServiceId (#PCDATA)>
<!ELEMENT SeqNo (#PCDATA)>
<-- **************** Card Balance definition *************-->
<!ELEMENT CardBalance (MappedCompanyId, CompanyId,
ExternalCompanyId, CardNo, DataRecordId, SystemNo, PrinNo,
AgentNo, CompanyAccNo, CycleCode, NoOfAccounts, CreditLimit,
Payments,
PastDueAmount, PastDueCount, ChargeOffAmt, NoOfPastDueAccs,
NoOfCards, OpeningBalance,
PaymentDueDate, CurrentBalance, DisputedAmount, ClosingDate,
CurrentDueAmount, BillingCurrencyCode,
BinNo, BitmapFlags, PastDueAmt30, PastDueAmt60, PastDueAmt90,
PastDueAmt120, PastDueAmt150,
PastDueAmt180, PastDueAmt181Plus, Interest, TcatOverlimitCharge,
TcatLateCharge, ImportCycleDate,
NoOfTransactions, CreditAmount, DebitAmount, LatestPaymentAmt,
LatestPaymentDate, FinanceCharges)>
<!ELEMENT MappedCompanyId (#PCDATA)>
<!ELEMENT CompanyId (#PCDATA)>
<!ELEMENT ExternalCompanyId (#PCDATA)>
<!ELEMENT CardNo (#PCDATA)>
<!ELEMENT DataRecordId (#PCDATA)>
<!ELEMENT SystemNo (#PCDATA)>
<!ELEMENT PrinNo (#PCDATA)>
<!ELEMENT AgentNo (#PCDATA)>
<!ELEMENT CompanyAccNo (#PCDATA)>
<!ELEMENT CycleCode (#PCDATA)>
<!ELEMENT NoOfAccounts (#PCDATA)>
<!ELEMENT CreditLimit (#PCDATA)>
<!ELEMENT Payments (#PCDATA)>
<!ELEMENT PastDueAmount (#PCDATA)>
<!ELEMENT PastDueCount (#PCDATA)>
<!ELEMENT ChargeOffAmt (#PCDATA)>
<!ELEMENT NoOfPastDueAccs (#PCDATA)>
<!ELEMENT NoOfCards (#PCDATA)>
<!ELEMENT OpeningBalance (#PCDATA)>
<!ELEMENT PaymentDueDate (#PCDATA)>
<!ELEMENT CurrentBalance (#PCDATA)>
<!ELEMENT DisputedAmount (#PCDATA)>
<!ELEMENT ClosingDate (#PCDATA)>
<!ELEMENT CurrentDueAmount (#PCDATA)>
<!ELEMENT BillingCurrencyCode (#PCDATA)>
<!ELEMENT BinNo (#PCDATA)>
<!ELEMENT BitmapFlags (#PCDATA)>
<!ELEMENT PastDueAmt30 (#PCDATA)>
<!ELEMENT PastDueAmt60 (#PCDATA)>
<!ELEMENT PastDueAmt90 (#PCDATA)>
<!ELEMENT PastDueAmt120 (#PGDATA)>
<!ELEMENT PastDueAmt150 (#PGDATA)>
<!ELEMENT PastDueAmt180 (#PCDATA)>
<!ELEMENT PastDueAmt181Plus (#PCDATA)>
<!ELEMENT Interest (#PCDATA)>
<!ELEMENT TcatOverlimitCharge (#PCDATA)>
<!ELEMENT TcatLateCharge (#PCDATA)>
<!ELEMENT ImportCycleDate (#PCDATA)>
<!ELEMENT NoOfTransactions (#PCDATA)>
<!ELEMENT CreditAmount (#PCDATA)>
<!ELEMENT DebitAmount (#PCDATA)>
<!ELEMENT LatestPaymentAmt (#PCDATA)>
<!ELEMENT LatestPaymentDate (#PCDATA)>
<!ELEMENT FinanceCharges (#PCDATA)>
<-- **************** Data Summary definition *************-->
<!ELEMENT DataSummary (InvoiceSummary, CardBalanceSummary,
CardSummary)>
<!ELEMENT InvoiceSummary (#PCDATA)>
<!ATTLIST InvoiceSummary NbTransaction CDATA #REQUIRED
NbAdditionalData CDATA #REQUIRED
NbLineItem CDATA #REQUIRED NbEnhancedData CDATA
#REQUIRED NbTripLeg CDATA #REQUIRED)>
<!ELEMENT CardBalanceSummary (#PCDATA)>
<!ELEMENT CardSummary (#PCDATA)>

1. A system for processing incoming data and inserting said incoming data into a database, comprising:
an incoming data receiving component, to connect to a source of data and receive incoming data;
a parsing component communicating with said incoming data receiving component, to receive and parse said incoming data as a function of a plurality of fields;
a loader component, in communication with said parsing component, to receive parsed data from said parsing component, and to sort said parsed data into a plurality of temporary tables as a function of said plurality of fields;
a data sorting component, in communication with said plurality of temporary tables and with said database, to access sorted data in said plurality of temporary tables, and to re-sort said sorted data into a plurality of tables in said database.

2. The system of claim 1 wherein said loader component performs the following steps:
processing said parsed data into a proper format for insertion into said database;
storing said parsed data in a file;
deactivating access to a temporary table in said database;
loading said file into said temporary table in said database; and
re-activating access to said temporary table.

3. The system of claim 1 wherein said data sorting component also inserts relational link information in said plurality of tables in said database.

4. The system of claim 1 wherein said data sorting component, upon accessing a data item in said temporary tables that indicates an error, moves said data item into a corresponding error table.

5. The system of claim 1 wherein:
said parsing component includes a generic parsing component having common functionality to parse data; and
wherein at least one specific function is implemented into a specific parsing component which encapsulates said generic parsing component, said at least one specific function modifying functionality of said generic parsing component so that said specific parsing component can parse data in a specific format.

6. The system of claim 5 wherein said at least one specific function overrides corresponding functionality in said generic parsing component.

7. The system of claim 1 wherein said data sorting component processes data in terms of one of: transaction data, line item data, additional data, enhanced data, trip leg data, and card balance data.

8. The system of claim 1 wherein said data is transactional data representing transactions completed using a commercial credit card.

9. The system of claim 8 wherein said data sorting component includes additional information in said data tables regarding tax information for said transactional data.

10. A method for loading data into a database comprising:
receiving data from a source of data;
parsing said data as a function of a plurality of fields to form parsed data;
sorting said parsed data into a plurality of temporary tables, said sorting being a function of said plurality of fields, to form sorted data; and
re-sorting and inserting said sorted data into tables in said database.

11. The method of claim 10 wherein said step of sorting said parsed data into a plurality of temporary tables includes:
processing said data into a proper format for insertion as formatted data into a database;
storing said formatted data in a file;
deactivating access to a temporary table in said database;
loading said formatted data from said file into said temporary table in said database; and
re-activating access to said data table.

12. The method of claim 10 further including:
during said step of inserting said sorted data into tables in said database, inserting relational link information to other tables in said database.

13. The method of claim 10 wherein said step of re-sorting and inserting said sorted data into tables in said database includes:
if a data item indicates an error, moving said data item into a corresponding error table in said database.

14. The method of claim 10 wherein said data is credit card transaction data.

15. The method of claim 10 wherein said step of parsing said data includes:
providing a generic parsing process, said generic parsing process including common functionality to parse data;
providing a set of specific functions to be implemented in a specific parsing process which encapsulates said generic parsing process, said set of specific functions modifying said generic parsing process so said generic parsing process includes functionality to parse data according to said set of specific functions.

16. The method of claim 15 wherein said set of specific functions override corresponding functions in said generic parsing process.

17. The method of claim 10 wherein said step of re-sorting and inserting said sorted data into tables in said database includes processing said sorted data in terms of one of: transaction data, line item data, additional data, enhanced data, trip leg data, and card balance data.
